(19) United States
(12) Patent Application Publication
(10) Pub. No.: US 2012/0176269 A1
(43) Pub. Date: Jul. 12, 2012

(54) Systems and Methods for Protection from Explosive Devices

(75) Inventors: James Jerome Holton, Alexandria, VA (US); Brian A. Ballard, Herndon, VA (US); Robert D. Kluesener, Arlington, VA (US)

(73) Assignee: ARES SYSTEMS GROUP, LLC, Great Falls, VA (US)

(21) Appl. No.: 12/488,009

(22) Filed: Jun. 19, 2009

Related U.S. Application Data
(60) Provisional application No. 61/142,089, filed on Dec. 31, 2008.

(51) Int. Cl. G01S 7/38

(52) U.S. Cl. 342/169

(57) ABSTRACT

Devices, systems and methods are disclosed which relate to reproducing and testing a simulation of electromagnetic propagation of multiple Radio Frequency (RF) jammers in an environment to determine the effectiveness of the jammer configuration. In some configurations, a multi-jammer simulator renders the electromagnetic propagation of a multiple jammer scenario, including multiple RF jammers onboard vehicles traveling through the environment, and records a multi-waveform output of the multiple jammer scenario to a recordable medium. A multi-waveform generator reads the multi-waveform output from the recordable medium and physically reproduces a plurality of waveforms consistent with the multi-waveform output. The plurality of waveforms is substantially similar to a physical reproduction of the multiple jammer scenario. An RF receiver, placed within a range of effectiveness of the multi-waveform generator, attempts to receive a signal from an RF transmitter during reproduction of the multi-waveform output. Results are recorded in the form of successes and failures associated with the attempts and compared with results from the simulation.

This application claims priority to U.S. Provisional Patent Application Ser. No. 61/142,089, filed Dec. 31, 2008, the content of which is hereby incorporated by reference in its entirety into this disclosure.

### BACKGROUND OF THE INVENTION

1. Field of the Invention

The present invention relates to the testing and rapid fielding of electromagnetic jammer systems. More specifically, the present invention relates to determining the effectiveness of jammer configurations.

2. Background of the Invention

Today's combat zones are very different than in any past conflict. Today's combat zones are asymmetrical with enemy combatants that avoid direct and open engagement, preferring instead to engineer improvised traps. Led by guerillas or commandos, these enemies often do not wear uniforms or march in lines, but are instead scattered and blend in with the general population of an area. Funding to these groups can be limited, so they improvise with available materials.

Improvised explosive devices (IEDs) are one of the most common and most deadly types of unconventional weapons used against conventional forces in the Middle East and worldwide. An IED is a bomb constructed and deployed in ways other than in conventional military action. For these under-funded guerilla groups, the IED represents a cheaper form of bomb that can take many different forms. Such IEDs are typically put together using available munitions and electronic components from standard consumer electronics, such as mobile telephones. Some IEDs are made from household chemicals while others are made using artillery shells manufactured by other militaries. This is because a guerilla soldier is not looking for a bomb that matches exact specifications, but a bomb that can be made with materials in the immediate proximity. For this reason it is very hard to envision what kind of bomb will be used next and how to protect against it.

Furthermore, there is an array of detonation techniques that guerillas will employ to remotely detonate a remote controlled improvised explosive device (RCIED). Different wireless technologies can be employed to detonate an RCIED including cellular telephones, garage door openers, car alarms, wireless door bells, encrypted General Mobile Radio Service (GMRS) radios, or any other wireless communication device. Often the transmitter and the receiver operate on a matched coding system which prevents the RCIED from detonating prematurely by spurious radio frequency signals.

Different kinds of wireless networks, physical geographies, and tactics have led not only to different counter measure devices being deployed on vehicles but also different software controlled instructions for how to jam the signal. One of the ways to address such RCIEDs and disarm them is by jamming the communication signal that is transmitted to the RCIED; this technique is the basis of operation for a currently widely deployed counter measure, Counter RCIED Electronic Warfare (CREW) systems. CREW systems are used to jam waveforms from electronic devices often used as triggers for RCIEDs. However, such jamming is not without its limitations, as multiple triggering devices with multiple waveforms may exist in any given geographical area.

For a vehicle equipped with one of these devices on its own, a combatant signal is generally jammed within a given safety zone extending outward from the CREW system. Counter to this point, vehicles are rarely on their own, often traveling in packs and in convoys on roads. With a large number of vehicles, multiple CREW systems are required to provide a zone of protection to the entire convoy of vehicles. With multiple CREW emitters in proximity to one another, the result is constructive and destructive interference spaces in the resultant field as well as interference with on-board “friendly” electronics and communications systems. So, for instance, with a 50 vehicle convoy with multiple vehicles outfitted with CREW systems, electromagnetic interference problems occur. This is even more complex as a change to the location of metal on a vehicle or the location of a CREW system antenna affects the emitted field, often in a major fashion. This may result in large gaps in the field of protection for that vehicle and those vehicles in proximity.

One class of vehicles right now that's being deployed with most of the new CREW systems is the Mine Resistant Ambush Protected (MRAP) vehicle. There are currently more than 200 variants of the vehicle, meaning that the number of possible arrangements of those vehicles in a two-vehicle convoy is greater than 200!/(200−2)!=39,800. Testing more than two vehicles at a time would give even more possibilities. The size of the testing problem becomes even larger as one considers that the spacing between the vehicles varies while in transit, as does the angular orientation between the vehicles (for example, when vehicles come to a stop or travel around turns). Further, the variations introduced by environmental factors add another dimension to the testing problem. Actually executing all these tests would require an extraordinary amount of time and would be prohibitively costly.

Thus, both the cost factor and the lengthy time to execute make the current testing method and approach not feasible to meet the urgent need for these and similar vehicles in the theater. The result is that the vehicles and their systems are not as extensively tested as would be preferred so that they may be shipped to theater quickly, or the vehicle testing is executed completely and the vehicles delivered far too late to be effective. Since the latter is not really an operational option, partial testing can potentially lead to convoy configurations that experience intermittent gaps in the coverage field. Operators would be unaware of these configurations and situations and would behave as though they are protected when it turns out that large sectors around them are completely uncovered, leaving them vulnerable. For example, with vehicles in convoys rolling along with a lead vehicle and several others in the convoy that are equipped with emitters, there may be unprotected vehicles in-between. Varying speeds only slightly may cause coverage gaps in different places. One can instruct operators to drive a constant 40 mph, but because of curves or other changes to the road they will need to periodically slow down. Every time a vehicle changes speeds, the space in-between vehicles changes. When the vehicle spacing changes, the field pattern changes such that a space on or along the edge of the road that may have been protected for the first part of the convoy suddenly ends up with a gap in the jamming coverage. If an IED were to be placed at the point where the gap appears, as soon as the jamming strength falls sufficiently, the IED can explode and cause casualties. These gaps can be extensive in some cases, possibly even as much as 45-90 degrees wide in certain situations.

Thus, what is needed in the art is a system to simulate and then produce complex waveforms of the type that are used for jamming communication to IEDs. Such systems and methods should be easy to understand and implement, and readily available to be set up worldwide. Such a system, after validation, would allow for the a priori computation of a jamming field in a very large number of convoy combinations and configurations, which then could be validated against threat devices of the day and new threat devices as they appear, all without having to repeat any experimental field tests involving the vehicles themselves.

### SUMMARY OF THE INVENTION

The present invention presents systems and methods for reproducing and testing a simulation of electromagnetic propagation of multiple Radio Frequency (RF) jammers in an environment to determine the effectiveness of the jammer configuration. In exemplary embodiments of the present invention a multi-jammer simulator renders the electromagnetic propagation of a multiple jammer scenario including multiple RF jammers onboard vehicles traveling through the environment, and records a multi-waveform output of the multiple jammer scenario to a recordable medium. A multi-waveform generator reads the multi-waveform output from the recordable medium and physically reproduces a plurality of waveforms consistent with the multi-waveform output. The plurality of waveforms is substantially similar to a physical reproduction of the multiple jammer scenario. An RF receiver, placed within a range of effectiveness of the multi-waveform generator, attempts to receive a signal from an RF transmitter during reproduction of the multi-waveform output. Results are recorded in the form of successes and failures associated with the attempts and compared with results from the simulation.

Furthermore, results from accurate and validated simulators assist in deriving algorithms for determining safe vehicle/troop formations in exemplary embodiments of the present invention. Military personnel use the safe formations to minimize destructive spaces created by interference from multiple RF jammers. The safe formations are used to guide military personnel into desired positions consistent with the safe formation. In some instances, GPS locators are used to give accurate direction. Military drivers are provided graphical indicators of a desired position versus an actual position and visual and audible warnings upon significant deviation from a desired position.

In one exemplary embodiment, the present invention is a system for physically reproducing a multi-waveform output generated by a simulation of a multiple jammer scenario. The system includes a multi-jammer simulator logic for creating a multiple jammer scenario that generates a multi-waveform output, a computer that executes the multi-jammer simulator logic and records the computed multi-waveform output to a recordable medium, and a multi-waveform generator that reads the multi-waveform output from the recordable medium and reproduces the multi-waveform output. The multi-waveform generator emits a plurality of waveforms substantially similar to a physical reproduction of the multiple jammer scenario.

In another exemplary embodiment, the present invention is a system for reproducing and testing a multi-waveform output generated by a multi-jammer simulator. The system includes a plurality of waveform generators, a wideband antenna in communication with the plurality of waveform generators which emits the multi-waveform output, a plurality of power amplifiers in communication with the plurality of waveform generators, a plurality of variable attenuators in communication with the plurality of waveform generators, a plurality of phase shifters in communication with the plurality of waveform generators, a CPU in communication with the plurality of waveform generators, a memory in communication with the CPU, a radio logic in communication with the CPU, a power supply in communication with the CPU, an RF receiver receiving at least a portion of the multi-waveform output, and an RF transmitter in communication with the receiver. The RF transmitter attempts to send a signal to the RF receiver while the multi-waveform output interferes with the RF receiver.

In yet another exemplary embodiment, the present invention is a method for verifying the accuracy of a multiple jammer scenario generated by a multi-jammer simulator. The method includes recording a multi-waveform output from a multi-jammer simulator onto a recordable medium, reproducing the multi-waveform output through a multi-waveform generator having a range of effectiveness, placing a receiver within the range of effectiveness of the multi-waveform generator, and attempting to transmit a signal from a transmitter to the receiver during reproduction of the multi-waveform output. The multi-waveform generator emits a plurality of waveforms substantially similar to a physical reproduction of the multiple jammer scenario.

### BRIEF DESCRIPTION OF THE DRAWINGS

FIG. 1 shows an area of unknown protection in a convoy due to constructive and destructive interference.

FIG. 2 shows a simulation and verification system utilizing a SWARM, according to an exemplary embodiment of the present invention.

FIG. 3 shows a flowchart of a method used by multi-jammer simulator logic, according to an exemplary embodiment of the present invention.

FIG. 4 shows components of a SWARM, according to an exemplary embodiment of the present invention.

FIG. 5 shows a flowchart of a method of testing and verification utilizing a SWARM, according to an exemplary embodiment of the present invention.

FIG. 6 shows an example of test detonation results, according to an exemplary embodiment of the present invention.

FIG. 7 shows areas in a convoy with different levels of protection within each jamming field due to constructive and destructive interference, according to an exemplary embodiment of the present invention.

FIG. 8 shows a driver warning system which utilizes the results of the testing and validation, according to an exemplary embodiment of the present invention.

FIG. 9 shows a driver warning system which utilizes the results of the testing and validation, according to an exemplary embodiment of the present invention.

### DETAILED DESCRIPTION OF THE INVENTION

The present invention presents systems and methods for reproducing and testing a simulation of electromagnetic propagation of multiple Radio Frequency (RF) jammers in an environment to determine the effectiveness of the jammer configuration. In exemplary embodiments of the present invention a multi-jammer simulator renders the electromagnetic propagation of a multiple jammer scenario including multiple RF jammers onboard vehicles traveling through the environment, and records a multi-waveform output of the multiple jammer scenario to a recordable medium. A multi-waveform generator reads the multi-waveform output from the recordable medium and physically reproduces a plurality of waveforms consistent with the multi-waveform output. The plurality of waveforms is substantially similar to a physical reproduction of the multiple jammer scenario. An RF receiver, placed within a range of effectiveness of the multi-waveform generator, attempts to receive a signal from an RF transmitter during reproduction of the multi-waveform output. Results are recorded in the form of successes and failures associated with the attempts and compared with results from the simulation.

The present invention represents a methodology and physical device to support substituting simulations of jammer systems in a widely configurable way, in various field conditions, as an alternative to the present process of costly and lengthy open-air testing. This invention accommodates a much greater degree of testing than does the current art while still offering the ability, via the physical device, to experimentally validate the simulation results against a real target, thus vastly reducing the time and cost of open-air testing and still delivering experimentally validated results.

Furthermore, results from accurate and validated simulators assist in deriving algorithms for determining safe vehicle formations in exemplary embodiments of the present invention. Military personnel use the safe formations to minimize destructive spaces created by interference from multiple RF jammers. The safe formations are used to guide military personnel into desired positions consistent with the safe formation. GPS locators are used to give accurate direction. Military drivers are provided graphical indicators of a desired position versus an actual position and visual and audible warnings upon significant deviation from a desired position.

A “waveform,” as used herein and throughout this disclosure, refers to a specific electromagnetic wave having a frequency, amplitude, and phase, etc. The visual representation of such a wave has a specific shape such as sinusoidal, square, triangle, sawtooth, etc.

An “RF jammer,” as used herein and throughout this disclosure, refers to a device which emits radio interference and saturates the environment with electromagnetic energy. This emission disrupts communication between RF devices by decreasing the signal to noise ratio. An RF jammer emits across a broad spectrum of frequencies encompassing high frequency (HF), very high frequency (VHF), ultra-high frequency (UHF), etc. Examples of an RF jammer include a CREW system, etc.

A “recordable medium,” as used herein and throughout this disclosure, refers to an electronic storage medium capable of being written to and read by a computer or other electronic input-output device. Examples of a recordable medium include hard drives, memory chips, flash drives, recordable compact discs, floppy disks, diskettes, tapes, etc.

An “RF receiver,” as used herein and throughout this disclosure, refers to a wireless communications receiver operating on one or more frequencies within the electromagnetic spectrum. An RF receiver may operate in a high frequency (HF), very high frequency (VHF), ultra-high frequency (UHF), etc. Examples of RF receivers include cellular telephones, car alarms, wireless door bells, etc.

An “RF transmitter,” as used herein and throughout this disclosure, refers to a wireless communications transmitter operating on one or more frequencies within the electromagnetic spectrum. An RF transmitter may operate in a high frequency (HF), very high frequency (VHF), ultra-high frequency (UHF), etc. Examples of RF transmitters include cellular telephones, car alarms, wireless door bells, etc.

For the following description and accompanying drawings, it may be presumed that labeled structures with a label having similar latter two digits (e.g., 132, 232 and 332, etc.) possess the same characteristics and are subject to the same structure and function. If there is a difference between correspondingly labeled elements that is not pointed out, and this difference results in a non-corresponding structure or function of an element for a particular embodiment, then that conflicting description given for that particular embodiment shall govern.

While embodiments of the present invention use the example of MRAPs for sake of convenience, other vehicle types are also used in caravans and may be simulated by a SWARM (Simulated Waveform and Amplitude Response Module) system according to the present invention. Thus, such other systems are also within the scope and purview of the present invention. For instance, Joint Light Tactical Vehicles (JLTVs), High Mobility Multipurpose Wheeled Vehicles (HMMWVs), and tanks may all be used in simulations according to the present invention. Additionally, while CREW systems and RF jammers are disclosed, other types of active emitting systems, such as RADAR, are also possible and may be simulated as described herein.

MRAPs almost always travel in packs when on missions in dangerous environments. The CREW systems onboard the MRAPs keep the soldiers safe from IED detonations in a field of protection. However, the CREW systems may interfere with each other, causing areas of constructive interference and areas of destructive interference. As the MRAPs pass a stationary point, that point passes through the fields of protection. When that point passes through an area covered by more than one field of protection the effectiveness of the protection becomes questionable due to interference of CREW systems with each other.

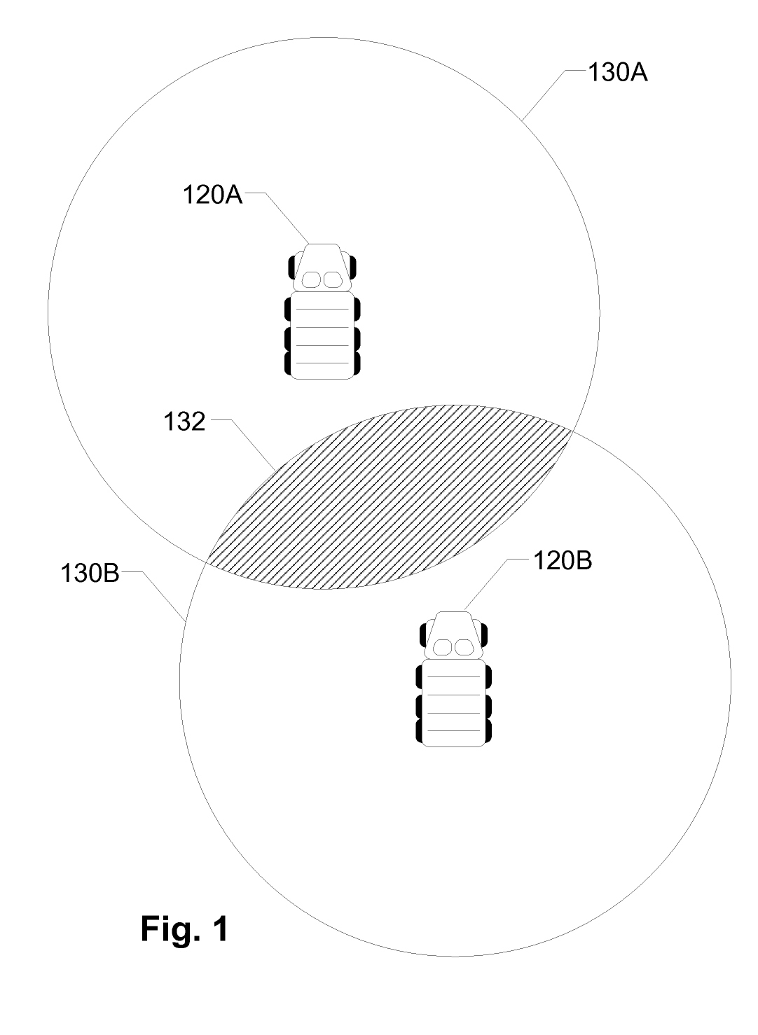

FIG. 1 shows an area of unknown protection in a convoy due to constructive and destructive interference. In this embodiment, a first MRAP 120A and a second MRAP 120B are driving in a formation. Both first MRAP 120A and second MRAP 120B have an onboard CREW system. The jamming field for first MRAP 120A is displayed as a first field 130A while the jamming field for the second MRAP 120B is displayed as a second field 130B. When driving alone, first field 130A and second field 130B generally cover an area around first MRAP 120A and second MRAP 120B, respectively. However, when in a formation, such as a convoy, first field 130A and second field 130B interact, creating constructive and destructive interference. Therefore, an unknown protection area 132 is created. In a hostile territory, an IED in unknown protection area 132 may possibly be detonated if first field 130A and second field 130B interfere with each other such that there is a gap in protection.

The fields of protection and the area of uncertainty in FIG. 1 is an oversimplification of the interference between two CREW systems. A field of protection generated by a CREW system or any RF jammer is rarely perfectly circular and does not have a defined edge. The emissions produced by an RF jammer are clear near the RF jammer, but fade as distance from the RF jammer increases. The ability for the electromagnetic waveforms, such as from an RF jammer, to travel through the atmosphere varies with temperature, pressure, etc. As the waveforms travel with time they interact with the surrounding objects and other waveforms in a process called electromagnetic propagation.

Since there are so many variables to be considered as waveforms undergo electromagnetic propagation, exemplary embodiments of the present invention utilize a computer running complex electromagnetic modeling software. This modeling software is used to render the electromagnetic propagation in a computer model which considers electromagnetic properties of every surface, volume, waveform, etc. This is useful for simulating the electromagnetic propagation from CREW systems mounted on MRAPs because it is otherwise so expensive and time consuming to physically reproduce. The simulation renders an accurate account of the electromagnetic propagation, but the resultant field of protection needs to be validated for effectiveness. The electromagnetic propagation is recorded to a recordable medium. The record of the electromagnetic propagation is referred to herein and throughout this disclosure as a multi-waveform output. A multi-waveform output includes a plurality of waveforms having distinct characteristics which are substantially similar to a physical reproduction of the simulation which rendered the electromagnetic propagation. A multi-waveform generator is used to physically emit the multi-waveform output, as evaluated for a particular point in space where a threat device would be located. An RF receiver is placed at this point as the multi-waveform output is emitted. An RF transmitter attempts to send a signal to the RF receiver during emission of the multi-waveform output. Predictions are made based on the simulation when the RF transmitter will be able to send a signal to the RF receiver and when the RF transmitter will not be able to send a signal to the RF receiver. If the predictions are correct, then the simulation is accurate. If the predictions are incorrect, then the simulation has flaws.

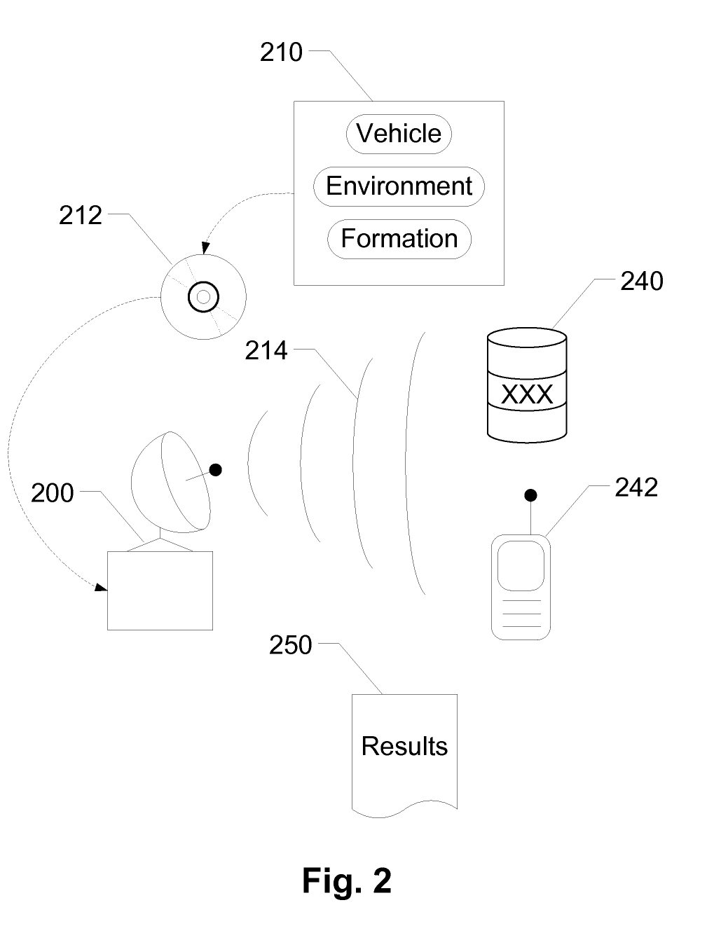

FIG. 2 shows a simulation and verification system utilizing a SWARM (Simulated Waveform and Amplitude Response Module), according to an exemplary embodiment of the present invention. In this embodiment, the system includes a SWARM 200, a multi-jammer simulator 210, a compact disc 212, a mock IED 240, a cellular telephone 242, and a plurality of results 250. The system allows for the simulation and verification of electromagnetic propagation of emitted fields of protection. Multi-jammer simulator 210 is a computer running electromagnetic propagation software which simulates variables in an environment, such as constructive and destructive interference, which affect jamming signals. Multi-jammer simulator 210 records a multi-waveform output onto compact disc 212. Multi-waveform output simulates the field strengths as it varies by frequency and time. Compact disc 212 is inserted into or communicates with SWARM 200. SWARM 200 outputs multi-waveform output recorded to compact disc 212 to test whether mock IED 240 can be triggered at certain points in time. While multi-jammer simulator 210 mimics the field strengths of the simulation as they vary by frequency and time at a specific location in space, cellular telephone 242 tries to trigger mock IED 240. During this validation, it is determined whether mock IED 240 was able to be triggered, and if so, when this occurred. The determination is recorded into results 250.

Alternate embodiments of the system in FIG. 2 include various types of RF receivers other than a mock IED. Some exemplary embodiments employ RF transmitters other than cellular telephones such as garage door openers, wireless doorbells, etc. Furthermore, exemplary embodiments test more than one RF receiver and/or RF transmitter at a time. For instance, an RF transmitter/receiver combination of each representative frequency range can be tested simultaneously.

The multi-jammer simulator is a computer which runs electromagnetic modeling software to render electromagnetic propagation. The electromagnetic modeling software includes many different programs, each program having a different specialty. For instance, when simulating a caravan of MRAP vehicles, variables may include the type of vehicles, the location of each CREW device, the placement of each CREW device on a vehicle, the spacing between vehicles, the surrounding environment, the speed of the vehicles, etc. For each variable, a software program is used to render all the electromagnetic properties associated with the variable. A complete model including all the variables is referred to herein and throughout this disclosure as a multiple jammer scenario. A multiple jammer scenario includes at least two RF jammers, each jammer onboard a vehicle, in motion as they pass a stationary point. A multi-jammer simulator logic is the bundle of programs that create, animate, and render the RF propagation of a multiple jammer scenario.

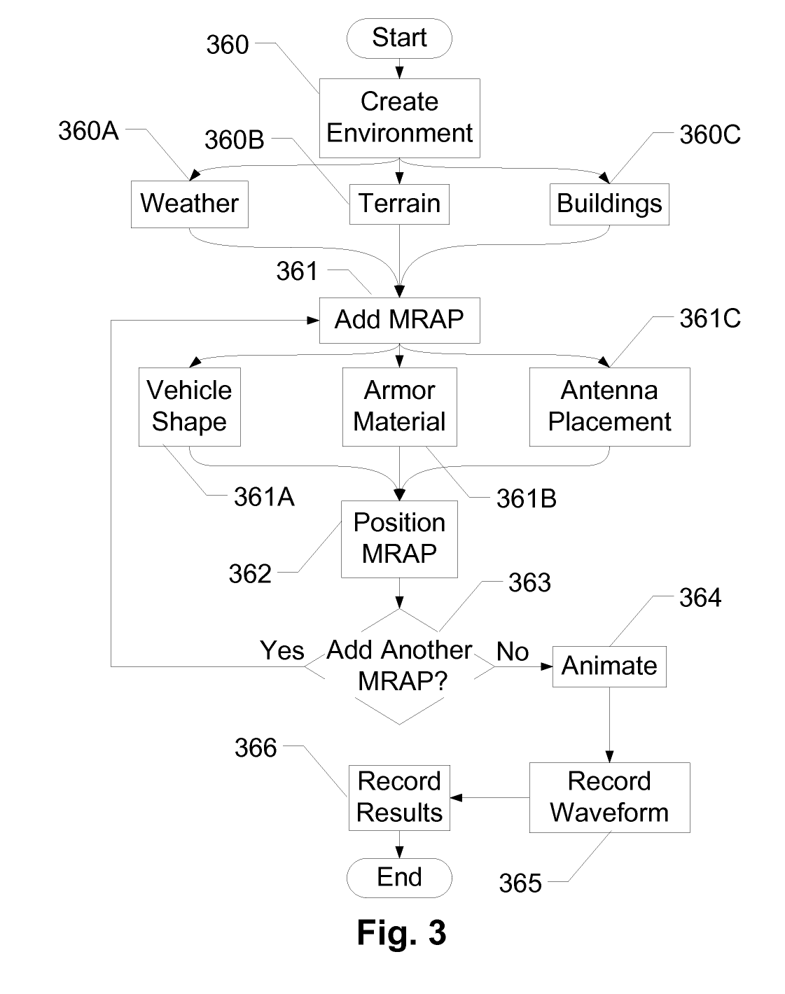

FIG. 3 shows a flowchart of a method used by a multi-jammer simulator logic, according to an exemplary embodiment of the present invention. In this embodiment, an environment 360 is first created. The creation of an environment includes adding a type of weather 360A, adding a terrain type 360B, and adding buildings, if any, to the environment 360C. With components of an environment added to the simulation, an MRAP is added 361. With the addition of the MRAP, a vehicle shape 361A, an armor material 361B, and an antenna placement 361C are chosen. With these characteristics of the MRAP chosen, the position of the MRAP is entered 362. Selecting the position of an MRAP allows the creator to form a caravan of MRAPs in specific formations. With the MRAP positioned, the creator may choose to add further MRAPs 363. If further MRAPs are created, each is given characteristics 361A, 361B, and 361C, as well as a position 362. Once all MRAPs have been entered into the simulation, the simulation is animated 364. During this animation, the simulation determines the electromagnetic propagation of the waveforms produced by the CREW systems based upon all of the entered factors. Waveforms are recorded to a recordable medium 365 based upon this animation. These waveforms, when played back through a multi-waveform generator, are substantially similar to a physical reproduction of a caravan with the entered factors moving past a point with all of the entered factors. The results of every simulation are recorded 366 and stored for later use.

Exemplary embodiments preferably use a trained technician to program the factors of a multiple jammer scenario into a multi-jammer simulator logic. Other exemplary embodiments are capable of handling vastly different environments as well as their respective electromagnetic properties. Urban environments, deserts, forests, etc., are programmed into the multi-jammer simulator logic. MRAPs are not the only vehicles capable of being modeled by the multi-jammer simulator logic either. Exemplary embodiments of the vehicle program of the multi-jammer simulator logic allow a programmer to specify exact shapes, sizes, materials, etc., ultimately allowing the programmer to program any vehicle whether in existence or purely hypothetical. Many programming options will become readily apparent to those having skill in the art.

As described above, an exemplary embodiment of the multi-waveform generator, used to reproduce the multi-waveform output, is called a SWARM (Simulated Waveform and Amplitude Response Module).

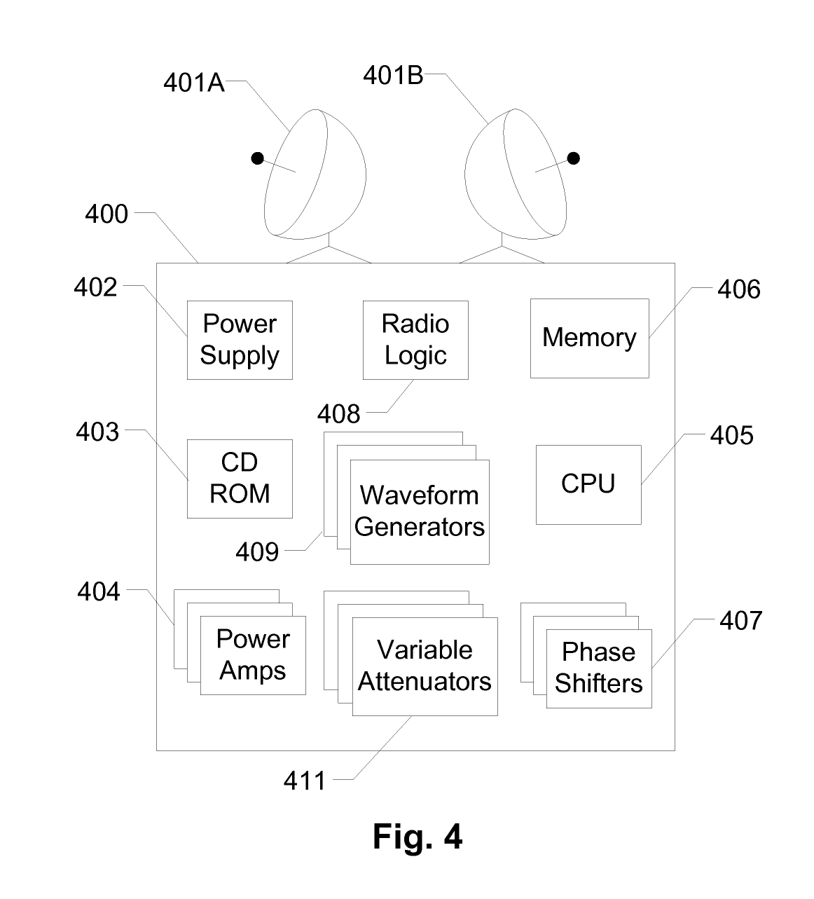

FIG. 4 shows components of a SWARM 400, according to an exemplary embodiment of the present invention. In this embodiment, the components include wideband antennas 401A and 401B, a power supply 402, a CD ROM drive 403, a plurality of power amplifiers 404, a plurality of waveform generators 405, a memory 406, a plurality of phase shifters 407, a radio logic 408, a central processing unit (CPU) 409, and a plurality of variable attenuators 411. Wideband antennas 401A and 401B emit waveforms which simulate field strengths as they vary by frequency and time at a specific location in space. Power supply 402 provides the necessary power for all of the other components. Power supply 402 may be battery powered, may plug into a wall socket, etc. CD ROM 403, or other drive or port, allows for the insertion of a compact disc, which holds a multi-waveform output. Power amplifiers 404 increase the amplitude to provide desired levels for each emitted waveform. Waveform generators 405 generate waveforms having a shape, frequency, and amplitude. Waveform generators 405 generate repeating and non-repeating signals which are further modified by power amplifiers 404, phase shifters 407, and variable attenuators 411. Memory 406 prepares data from other components to be processed by CPU 409. Phase shifters 407 provide a continuously variable phase shift or time delay, or provide a discrete set of phase shifts or time delays for each waveform. Radio logic 408 interprets the multi-waveform output on a compact disc into commands given to CPU 409 for the functioning of SWARM 400. CPU 409 executes radio logic 408 and controls functions of each of the components. Variable attenuators 411 reduce the amplitude or power of the signals without appreciably distorting each waveform. Variable attenuators 411, along with other components, allow SWARM 400 to output waveforms which are substantially similar to a physical reproduction of a multi-jammer scenario.

Exemplary embodiments employ more and less wideband antennas depending on the specific application. The number of waveform generators and other components of a multi-waveform generator may be limited by the processing power of the CPU. However, exemplary embodiments employ more and less powerful CPUs. Since many other recordable mediums for the multi-waveform output exist, exemplary embodiments of the multi-waveform generator utilize drives capable of reading all recordable mediums. Other exemplary embodiments contain Ethernet ports, universal serial bus (USB) ports, or other types of direct data communication. For instance, the multi-waveform generator may have a direct link to the simulation engine itself, negating the need for a recordable medium. Further embodiments employ wireless technology, such as BLUETOOTH, WiFi, etc., to transfer the multi-waveform output wirelessly. Other methods of data transfer will be readily apparent to those having skill in the art. All of these components of the multi-waveform generator work together to reproduce as many waveforms and to reproduce every characteristic of each waveform as close to an actual physical reproduction of a multiple jammer scenario as possible. Other components used to control specific characteristics of waveforms will be apparent to those having skill in the art. In exemplary embodiments the multi-waveform generator is covered by a weatherproof enclosure.

The multi-waveform generator emits a multi-waveform output substantially similar to a physical reproduction of a multiple jammer scenario. During the emission, a test is run to see if and when an RF transmitter is able to send a signal to an RF receiver. However, there are many possibilities of scenarios that a multi-jammer simulator can address. For instance, if the simulator is limited to MRAP vehicles with CREW systems, this still yields well over 10⁵⁴ possibilities. An MRAP currently has more than 200 variations, with some variations being more prevalent than others. The electromagnetic propagation changes depending on each variation. This change compounds with the location of the emitter for the CREW system as well as the orientation of the emitter in each position. With this exponentially large number of possibilities, only a few are tested for accuracy under the assumption that if the tested models are accurate, then the untested models must be accurate as well, provided a significant portion of the models are tested. Though each test works as sort of a “spot check” of the simulation, the simulation outputs much more detail than simply whether an RF receiver can be triggered at a time and location.

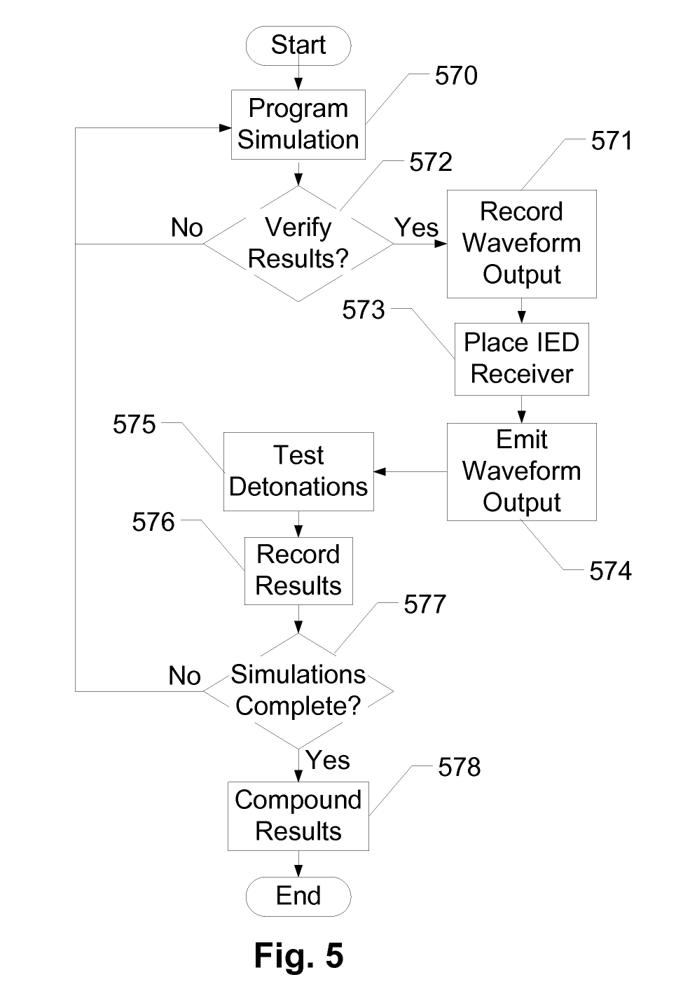

FIG. 5 shows a flowchart of a method of testing and verification utilizing a SWARM system, according to an exemplary embodiment of the present invention. In this embodiment, the method begins by programming a simulation 570 of a multiple jammer scenario. Once the simulation has rendered the electromagnetic propagation, it is determined whether or not to verify the results of the simulation 572. If verification is not desired, a new program simulation is run 570. If verification is desired, a multi-waveform output is recorded 571 from the simulation. With the multi-waveform output recorded and the verification desired, an IED receiver is placed 573 in a position within the range of effectiveness of a SWARM. The multi-waveform output is emitted 574 using a SWARM. During the emission, the capability of detonation is tested 575. For instance, a user attempts to detonate the IED using a cellular telephone while the SWARM is emitting a multi-waveform output substantially similar to a jamming signal from a caravan. The results of the test detonations are recorded 576 at specific instances in time. With the results recorded, it is determined whether all of the desired simulations are complete 577. If more simulations are desired, the method begins again by programming a new simulation 570. If the simulations are complete, the results are compounded 578 such that one can determine at which times there are vulnerabilities to a field of protection and at what location.

Embodiments of the verification process test larger and smaller portions of the total amount of simulations depending on the desired degree of accuracy. RF receivers and transmitters using all ranges along the electromagnetic spectrum are used in exemplary embodiments to verify broad protection. Since there is such a large amount of multiple jammer scenarios, results are often compounded before completion of simulation of every single variation. Simulations are divided into sets in certain embodiments, where each set represents one model of MRAP or one particular formation. Results from each set of simulations are compounded once the simulator has been verified as accurate throughout the set.

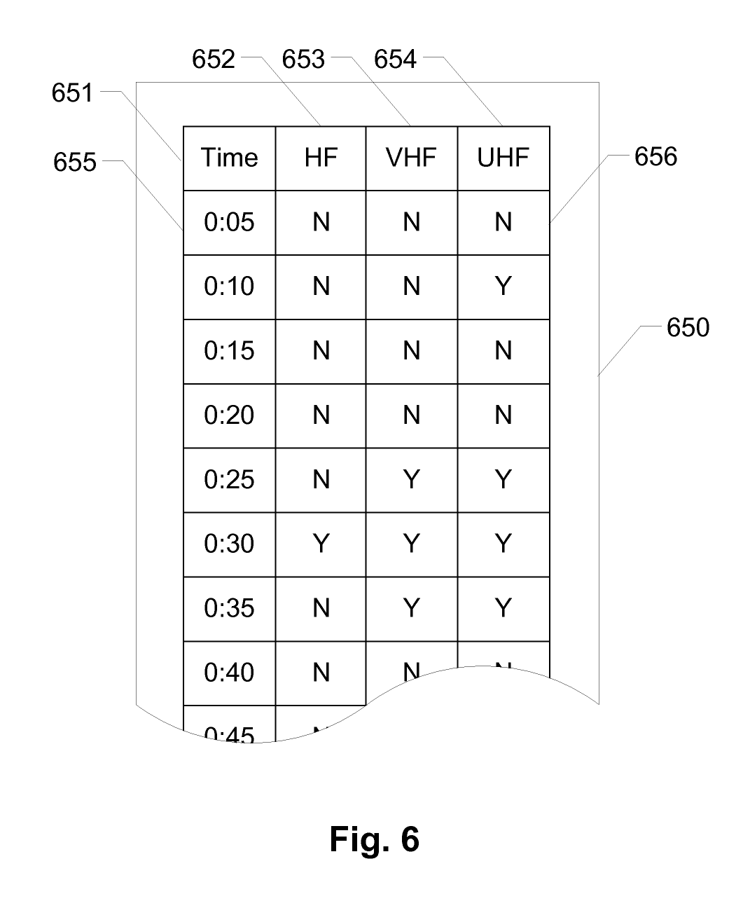

FIG. 6 shows an example of test detonation results 650, according to an exemplary embodiment of the present invention. In this embodiment, test detonation results 650 include a time 651 of the detonation attempt as well as a type of attempt, including high frequency (HF) 652, very high frequency (VHF) 653, and ultra high frequency (UHF) 654. HF 652 triggers operate in the radio frequency range of 3 to 30 MHz. This encompasses such devices as garage door openers and CB radios. VHF 653 triggers operate in the radio frequency range of 30 to 300 MHz. This encompasses uses such as FM radio broadcast and television broadcast. UHF 654 triggers operate in the radio frequency range of 300 MHz to 3 GHz. This encompasses uses such as mobile telephones. Test detonation results 650, for example, show that at a time of 5 seconds, the row including position 655, the UHF signal was not able to detonate a mock IED, shown by an N at a position 656 where the time of 5 seconds intersects the UHF 654 column.

In other exemplary embodiments of the test results a broader range of frequencies are used in the RF receivers and transmitters to test the complete bounds of RF jammers. Time intervals also vary from embodiment to embodiment. In some exemplary embodiments, rather than the test results being a simple yes or no, referring to whether or not a signal was successfully transmitted from the RF transmitter to the RF receiver, the result of a single attempt can be one of degree. For instance, an RF transmitter can transmit a more or less powerful signal to an RF receiver. Depending on the power of the jamming waveforms, a powerful enough signal may still be received by an RF receiver. Therefore, instead of one level of power being used to test each frequency and yielding a yes or no, a result can be a threshold power level up to which the jamming field is effective but above which the jamming field is not.

From the results of verified multi-jammer simulators, emulations can be created showing weak areas in fields of protection surrounding RF jammers for specific scenarios. The constructive and destructive interference within overlapping jamming fields yields weak areas, suboptimal areas, unaffected areas, etc. Essentially, an emulation, as in the overly simplistic FIG. 1 where there are simply unknown protection areas, is derived from the body of results which shed light on previously unknown protection areas.

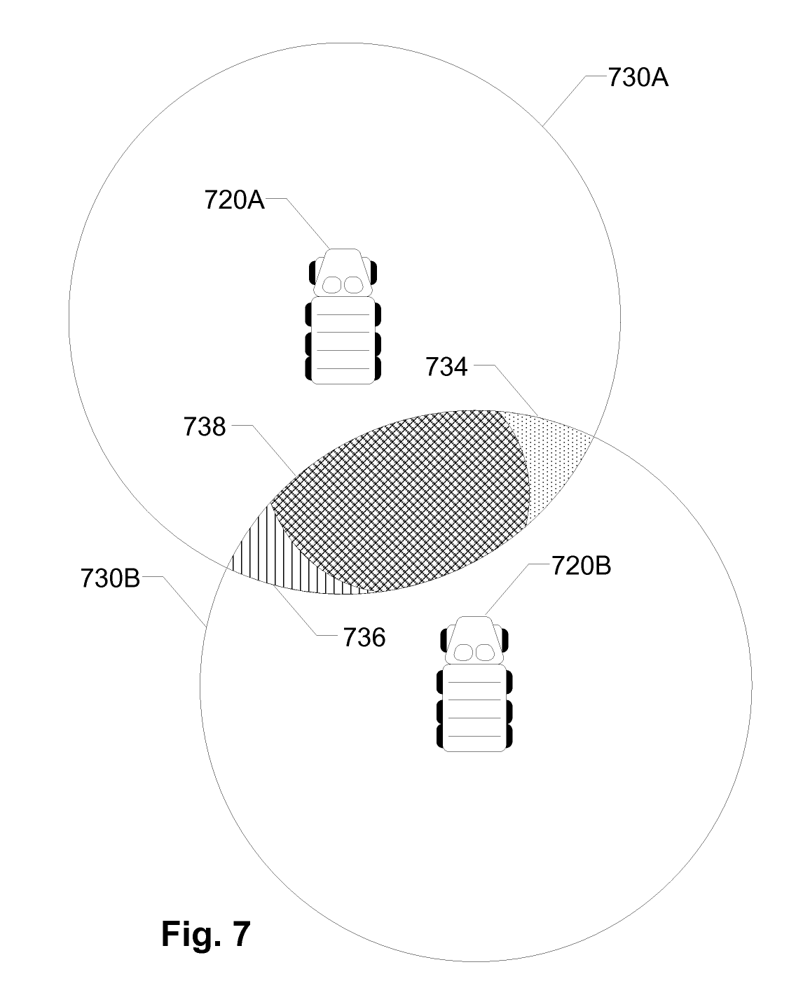

FIG. 7 shows areas in a convoy with different levels of protection within each jamming field due to constructive and destructive interference, according to an exemplary embodiment of the present invention. In this embodiment, a first MRAP 720A and a second MRAP 720B are driving in a formation. Both first MRAP 720A and second MRAP 720B have an onboard CREW system which emits a jamming field. The jamming field for first MRAP 720A is displayed as a first field 730A while the jamming field for the second MRAP 720B is displayed as a second field 730B. When driving alone, first field 730A and second field 730B adequately protect an area around first MRAP 720A and second MRAP 720B respectively. However, when in a formation, such as a convoy, first field 730A and second field 730B interact, creating constructive and destructive interference. After running simulations and validating with a multi-waveform generator, these levels of protection become apparent. For instance, in the present embodiment, a first area 738 may have poor protection due to interference, a second area 734 may have moderate protection due to interference, and a third area 736 may have high but sub-optimal protection due to the interference. With protection known for a variety of formations, optimal alignments of vehicles may be found.

These optimal alignments of vehicles are also known as safe formations. Safe formations can vary with vehicle models, environments, etc., but all are utilized because they yield the most protection even in areas of constructive and destructive interference. By using safe formations, vehicles can travel in convoys while protected by an RF jamming field. Drivers may stay in formation themselves or receive help by communicating with a third party. In exemplary embodiments, a vehicle is equipped with a GPS receiver which gives the coordinates of the vehicle. A third party may monitor the coordinates of all of the vehicles in a convoy while instructing those who make a significant deviation from the safe formation back to their desired position.

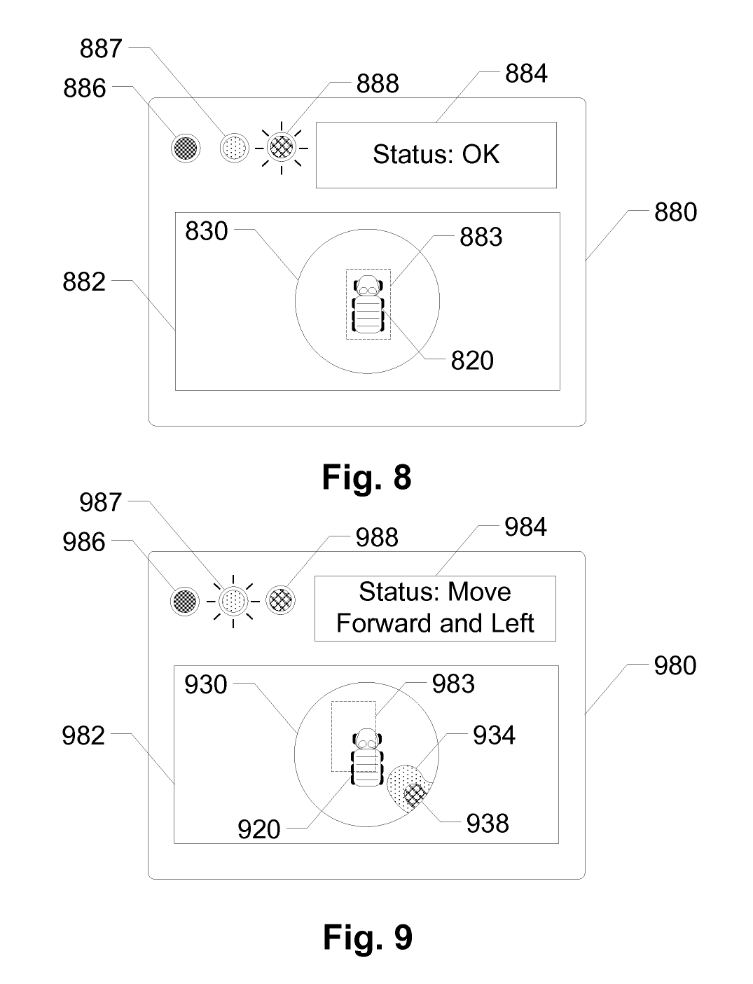

FIG. 8 shows a driver warning system 880 which utilizes the results of the testing and validation, according to an exemplary embodiment of the present invention. In this embodiment, driver warning system 880 includes a display 882 with an MRAP icon 820, a jamming signal icon 830 around MRAP 820, and a desired position icon 883 for MRAP 820. Driver warning system 880 also includes a location status 884 as well as a green light 888, a yellow light 887, and a red light 886. In this figure, MRAP 820 is completely within desired position 883, the box around MRAP 820. As MRAP 820 is completely within desired position 883, location status 884 tells a driver that he is ok and in the desired position 883. Additionally, because MRAP 820 is completely within desired position 883, green light 888 is lit. Green light 888 signifies that the driver has MRAP 820 in the correct position relative to the ability of CREWs within a caravan to jam signals. Yellow light 887 signifies that MRAP 820 has significantly deviated from the desired position 883. Yellow light 887 warns the driver to get back into position to improve protection from IEDs. Red light 886 signifies that MRAP 820 is dangerously out of position and may be vulnerable to IED attack. Red light 886 warns the driver to quickly get back into position.

FIG. 9 shows a driver warning system 980 which utilizes the results of the testing and validation, according to an exemplary embodiment of the present invention. In this embodiment, driver warning system 980 includes a display 982 with a representation of an MRAP 920, a representation of a jamming signal 930 around MRAP 920, a desired position 983 for MRAP 920, an area of moderate protection 934, and an area of low protection 938. Driver warning system 980 also includes a location status 984 as well as a green light 988, a yellow light 987, and a red light 986. In this figure, MRAP 920 is partially outside desired position 983. From the simulation and validation results, a coordinates monitor knows that by the specific deviation of MRAP 920, MRAP 920 is now close to area of moderate protection 934 followed by area of low protection 938. Thus, MRAP 920 has fallen out of formation and towards these areas 934 and 938, rendering MRAP 920 inadequately protected from IED attacks. Area of moderate protection 934 and area of low protection 938 are created by constructive and destructive interference of the signals from a CREW system onboard one or more MRAPs in the caravan. Location status 984 informs a driver that the driver needs to more forward and left in order to get back to desired position 983. Yellow light 987 is lit, informing the driver that MRAP 920 has significantly deviated from desired position 983. If the driver gets dangerously out of position, red light 986 lights up. If the driver gets back into ideal position 983, green light 988 lights up.

Some exemplary embodiments of the visual indicators receive instruction wirelessly from a server making calculations for each vehicle in a caravan, while vehicles in other exemplary embodiments each have their own electronic coordinate monitor. The electronic coordinate monitor calculates its own coordinates and communicates wirelessly with electronic coordinate monitors in nearby vehicles.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system for physically reproducing a multi-waveform output generated by a simulation of a multiple jammer scenario comprising:
a multi-jammer simulator logic for creating a multiple jammer scenario which generates a multi-waveform output;
a computer which executes the multi-jammer simulator logic and records the multi-waveform output to a recordable medium; and
a multi-waveform generator which reads the multi-waveform output from the recordable medium and reproduces the multi-waveform output;
wherein the multi-waveform generator emits a plurality of waveforms substantially similar to a physical reproduction of the multiple jammer scenario.

2. The system of claim 1, wherein the multi-jammer simulator logic includes an environment modeling logic, a vehicle modeling logic, an antenna modeling logic, an animation logic, and an electromagnetic propagation logic.

3. The system of claim 2, wherein the environment modeling logic includes a weather modeling logic, a terrain modeling logic, and a buildings modeling logic.

4. The system of claim 1, wherein the multiple jammer scenario includes a plurality of vehicles having a plurality of RF jammers moving through an environment.

5. The system of claim 4, wherein the plurality of vehicles includes one or more of an MRAP, a JLTV, an HMMWV, and a tank.

6. The system of claim 4, wherein the plurality of RF jammers includes a CREW system.

7. The system of claim 1, wherein the multi-waveform generator includes a plurality of waveform generators, a variable attenuator, a phase shifter, a power amp, a power supply, and at least one wideband antenna.

8. A system for reproducing and testing a multi-waveform output generated by a multi-jammer simulator comprising:
a plurality of waveform generators;
a wideband antenna in communication with the plurality of waveform generators which emits the multi-waveform output;
a plurality of power amplifiers in communication with the plurality of waveform generators;
a plurality of variable attenuators in communication with the plurality of waveform generators;
a plurality of phase shifters in communication with the plurality of waveform generators;
a CPU in communication with the plurality of waveform generators;
a memory in communication with the CPU;
a radio logic in communication with the CPU;
a power supply in communication with the CPU;
an RF receiver receiving at least a portion of the multi-waveform output; and
an RF transmitter in communication with the receiver;
wherein the RF transmitter attempts to send a signal to the RF receiver while the multi-waveform output interferes with the RF receiver.

9. The system of claim 8, wherein the multi-waveform output includes a plurality of waveforms substantially similar to a physical reproduction of a multiple jammer scenario.

10. The system of claim 9, wherein the multiple jammer scenario includes a plurality of vehicles having a plurality of RF jammers moving through an environment.

11. The system of claim 10, wherein the plurality of vehicles includes one or more of an MRAP, a JLTV, an HMMWV, and a tank.

12. The system of claim 10, wherein the plurality of RF jammers includes a CREW system.

13. The system of claim 8, wherein the receiver is a detonation trigger.

14. The system of claim 13, wherein the detonation trigger is substantially similar to a detonation trigger for an IED.

15. The system of claim 13, wherein the detonation trigger is one of a cellular telephone, garage door opener, wireless door bell, and a car alarm.

16. The system of claim 8, wherein the transmitter is one of a cellular telephone, garage door opener, wireless door bell, and a car alarm.

17. A method for verifying the accuracy of a multiple jammer scenario generated by a multi-jammer simulator comprising:
recording a multi-waveform output from a multi-jammer simulator onto a recordable medium;
reproducing the multi-waveform output through a multi-waveform generator having a range of effectiveness;
placing a receiver within the range of effectiveness of the multi-waveform generator; and
attempting to transmit a signal from a transmitter to the receiver during reproduction of the multi-waveform output;
wherein the multi-waveform generator emits a plurality of waveforms substantially similar to a physical reproduction of the multiple jammer scenario.

18. The method of claim 17, further comprising
creating an environment and a plurality of vehicles having a plurality of RF jammers within the multi-jammer simulator;
animating at least one vehicle through the environment; and
rendering the electromagnetic propagation of the plurality of waveforms produced by the plurality of RF jammers as the plurality of waveforms interact with the environment, the vehicles, and each other into the multi-waveform output.

19. The method of claim 17, further comprising recording a result from the attempt to transmit a signal.

20. The method of claim 19, further comprising
compounding a plurality of results from a plurality of attempts;
analyzing the plurality of results; and
deriving an algorithm for determining a safe formation.

21. The method of claim 20, further comprising guiding a driver into a desired position consistent with the safe formation.

22. The method of claim 21, further comprising displaying a graphical indication of the desired position and an actual position.

23. The method of claim 21, further comprising warning a driver upon significant deviation from the desired position.

24. The method of claim 21, further comprising using a GPS receiver.
